(19) United States
(12) Patent Application Publication
(10) Pub. No.: US 2014/0197662 A1
(43) Pub. Date: Jul. 17, 2014

(54) WHEEL OPENING FENDER/PANEL ASSEMBLY

(71) Applicant: Vincent A. Runfola, Apopka, FL (US)

(72) Inventor: Vincent A. Runfola, Apopka, FL (US)

(21) Appl. No.: 14/152,575

(22) Filed: Jan. 10, 2014

Related U.S. Application Data
(60) Provisional application No. 61/751,473, filed on Jan. 11, 2013.

(51) Int. Cl. B62D 25/16

(52) U.S. Cl. CPC B62D 25/163
USPC 296/198

(57) ABSTRACT

A wheel opening fender panel assembly for a vehicle includes an upper panel, a lower portion defining at least one leg and a coupler for removably coupling the upper panel and the lower portion. The coupler is a folding coupler or a break-a-way coupler.

### CROSS REFERENCE TO RELATED APPLICATIONS

This is a non-provisional application based upon U.S. Provisional Patent Application Ser. No. 61/751,473, entitled “WHEEL OPENING FENDER/PANEL ASSEMBLY WITH FOLDING/BREAKAWAY REPLACEABLE LEGS”, filed Jan. 11, 2013, which is incorporated herein by reference.

### BACKGROUND OF THE INVENTION

1. Field of the Invention

The present invention relates to fenders and panels with wheel openings on vehicles.

2. Description of the Related Art

The majority of current bus and trailer wheel opening fender panel assemblies have a one piece design. The forward and aft fender legs on the wheel opening fender/panel assemblies have a one piece design. The forward and aft fender legs on the wheel opening fender/panel assemblies are prone to impact damage due to limited driver's visibility while turning. Also, the majority of impact damage occurs at the lower portion of the forward and aft fender legs of the fender/panel assembly requiring costly replacement of the entire assembly or removal of the entire assembly to make repairs creating costly downtime.

With conventional designs, when minor lower fender leg damage is sustained, the following results occur: 1) removal, repair and/or replacement of entire fender/panel assembly; 2) high labor cost is incurred to remove, repair and/or replace the entire wheel opening fender assembly; and 3) high cost is incurred with the vehicle out of service during the removal, repair and/or replacement process.

What is needed in the art is a fender and panel with wheel openings for a vehicle which allows for simple, efficient and cost effective repair or replacement and a method for use thereof.

### SUMMARY OF THE INVENTION

The present invention provides a wheel opening fender panel assembly for a vehicle including an upper panel, a lower portion which defines at least one leg and a coupler for removably coupling the upper panel and the lower portion. The coupler according to the present invention is a folding coupler or a break-away coupler.

The invention in another form is directed to a wheel opening fender assembly including an upper panel including a flange, a lower portion defining at least one leg and including a flange and a coupler for removably coupling the flange of the upper panel and the lower portion in a compression fit. The coupler according to the present invention is a folding coupler or a break-a-way coupler.

An advantage of the present invention is that upon impact at the lower portion of the fender leg(s), the wheel opening fender panel assembly provides that the legs fold in and/or break away from the upper panel of the assembly without transferring any damage to the upper panel of the assembly. Also, when lower fender leg damage occurs, it is no longer necessary to remove or replace the entire fender panel, but rather just the damaged lower fender legs. The damaged folding or breakaway legs easily detach from the upper panel of the assembly and the new replaceable legs are readily attached to the upper panel. Accordingly, a vehicle may be back in service within minutes, instead of hours or days.

Further advantageously, since only those sections which are typically damaged, for example forward and aft fender legs, are likely to be replaced, it will only be necessary to keep these smaller components in stock, rather than large, single piece wheel opening panels, thereby allowing for inventory cost reduction.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an inside of a wheel opening fender panel assembly according to the present invention;

FIG. 2 is a sectional view of the wheel opening fender panel assembly according to FIG. 1;

FIG. 3 is a sectional view of a wheel opening fender assembly according to the present invention with a second embodiment of a coupler;

FIG. 4 is a sectional view of a wheel opening fender assembly according to the present invention with a third embodiment of a coupler; and

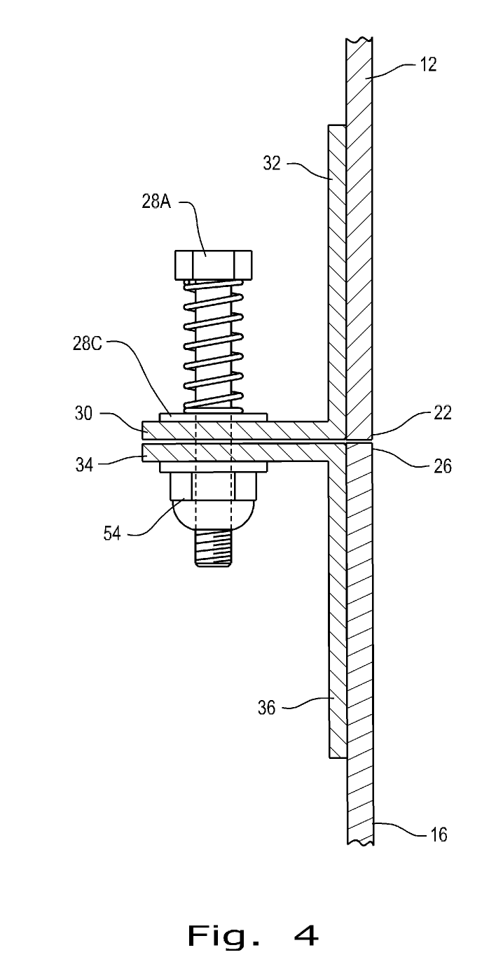

FIG. 5 is a stabilizing hinge block according to the present invention, illustrated in FIG. 3.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

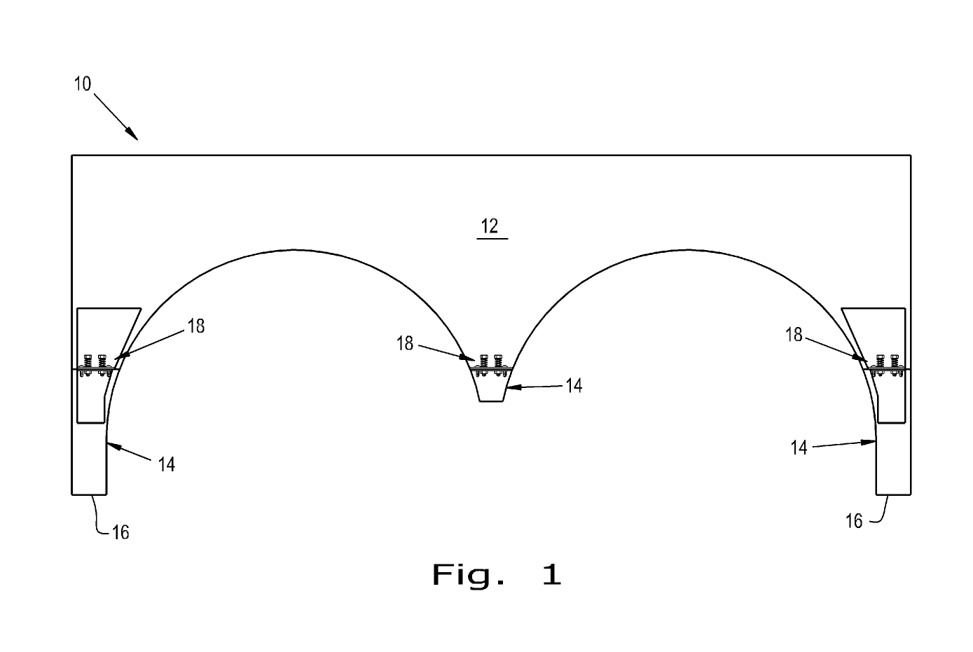

Referring now to the drawings, and more particularly to FIG. 1, there is shown a rear view of a wheel opening fender panel assembly 10 which generally includes an upper panel 12, a lower portion 14 defining at least one leg 16, and a coupler 18. Coupler 18 is a folding coupler or a break-a-way coupler 18.

Upper panel 12 is, for example formed of fiberglass, a composite material or metal and has a rigidity which is greater than that of lower portion 14. Lower fender portion 14 may also be formed of, for example, fiberglass, a composite material or metal. Lower fender portion 14 defines at least one leg 16, which may include, for example a plurality of legs 16, such as a forward fender leg 16 and an aft leg 16.

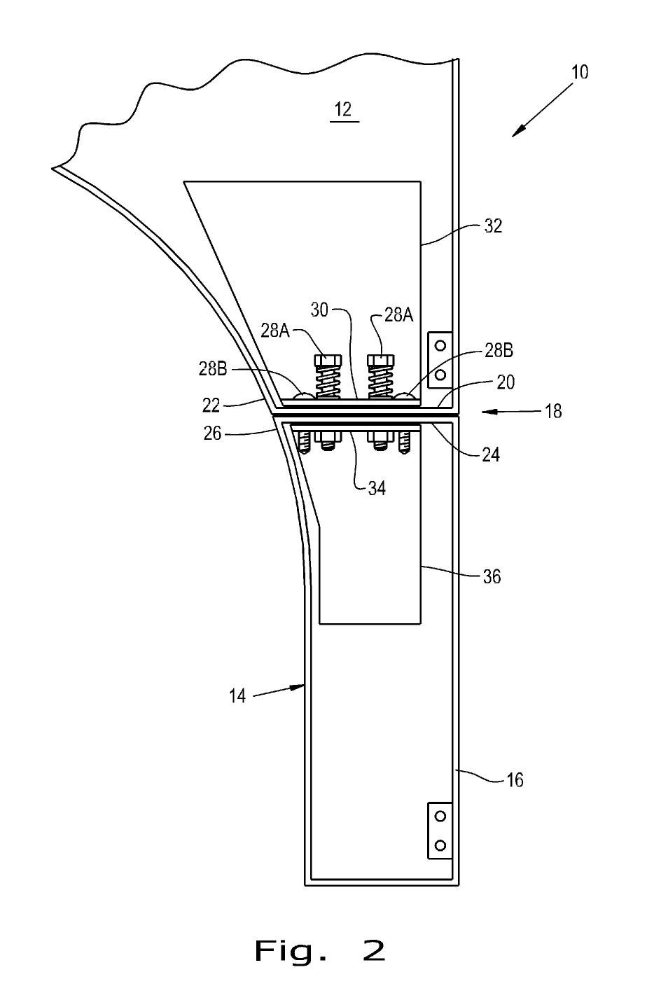

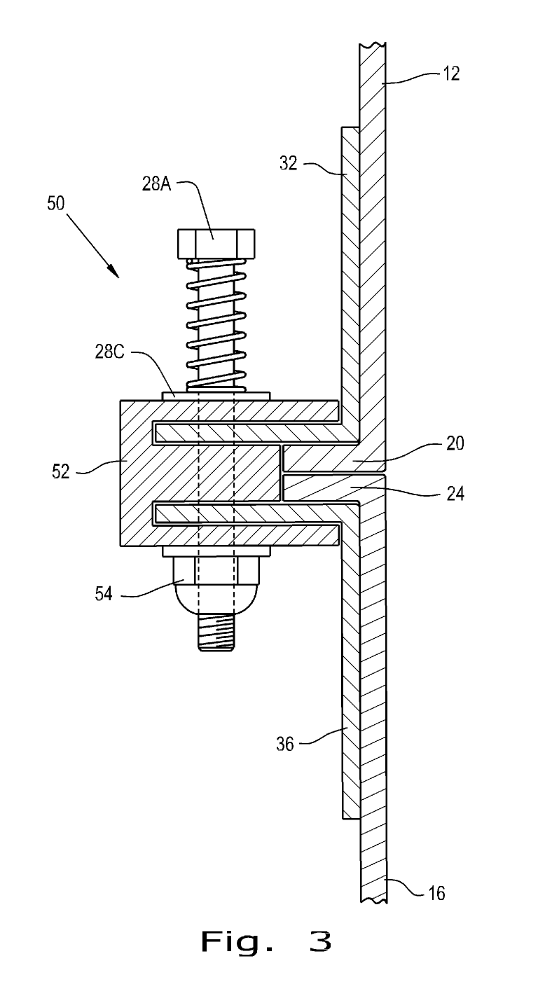

As illustrated in FIGS. 2 and 3, upper panel 12 may define, for example, a flange 20 positioned along a lower edge 22 of upper panel 12. Correspondingly, lower portion 14 defines a second flange 24 along an upper edge 26 of leg 16. Flanges 20, 24 are attached together using one or more couplers 18.

Referring now to FIG. 2, there is shown a sectional view of an embodiment of a wheel opening fender panel assembly 10 according to the present invention. A coupler 18 secures upper panel 12 to lower fender portion 14 and is formed, for example, of metal (ferrous or non-ferrous), composite, plastic and/or rubber. Coupler 18 includes at least one attachment member 28, which is in the form of, for example, a rigid metal bolt, a bendable metal bolt, a bendable composite bolt, a breakable composite bolt, a composite breakable guide pin, a metal guide pin, a compression spring, a spacer, a flexible hinge, a composite bungee, a lanyard or any combination thereof. The aforementioned bendable bolts have sufficient flexibility to bend without damaging the upper attachment plate 30 and lower attachment plate 34 of coupler 18. Additionally, rigid bolts or attachment members 28 may be provided which have an area configured to be a weak point such that upon impact, the attachment member 28 breaks at the weak point without transferring damage to the upper panel 12. Attachment members 28 may be formed from any known metal, composite or plastic material, including nylon. Attachment members 28 shown in FIG. 2 are in the form of a pair of compression spring mounting bolts 28A and a pair of guide pins 28B. Upper attachment plate 30 of coupler 18 may include a flange 32 and lower attachment plate 34 include another flange 36, as illustrated in FIG. 2. Here, flange 32 of upper plate 30 is positioned against flange 20 of upper panel 12 and flange 36 of lower plate 34 is positioned against flange 24 of leg 16. Attachment members 28 are then guided through a plurality corresponding openings through each of flanges 20, 24, 32 and 36 and upper panel 12, lower leg 16, upper plate 30 and lower plate 34 are secured in position by attachment members 28 in a compression fit with a locking-type nut 54. It is also feasible to utilize a rigid or flexible mounting bolt without a compression spring as attachment means 28. In this case, a bungee or a lanyard may be utilized to additionally secure lower leg 16 to upper panel 12.

Although FIG. 2 illustrates the wheel opening fender panel assembly 10 as including upper plate 30 and lower plate 34, it is feasible for these components to be eliminated and flange 20 of upper panel 12 be coupled directly with flange 24 of leg 16 with attachment members 28, for example in the embodiment of mounting bolts 28A and guide pins 28B. According to this embodiment, the coupler 18 in the form of attachment members 28 are break-a-way attachment members and/or folding attachment members.

Referring now to FIG. 3, there is shown an additional embodiment of a wheel opening fender panel assembly 50 according to the present invention. Here, flange 20 of upper panel 12 is shown abutting flange 24 of leg 16. Additionally, flange 32 of upper plate 30 of coupler 18 is positioned on top of and abutting flange 20 of upper panel 12, while flange 36 of lower plate 34 of coupler 18 is positioned directly against flange 24 of leg 16. A stabilizing hinge block 52 is positioned between and around flanges 32 and 36 of the upper plate 30 and lower plate 34 of coupler 18 respectively. Here again, a compression spring mounting bolt 28A is passed through an opening (not shown) in each of flanges 32 and 36 of the upper plate 30 and lower plate 34 of coupler 18 and secured, along with a spacer 28C to form a compression fit, securing each of the upper panel 12, leg 16, upper plate 30, lower plate 34 and stabilizing hinge block 52 in position.

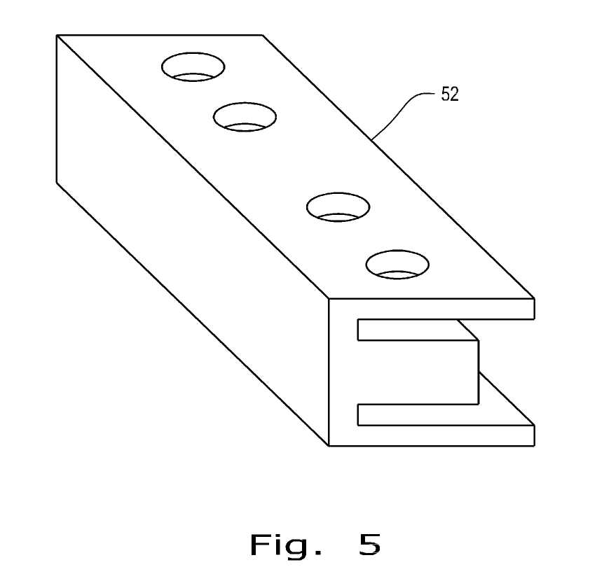

Referring now to FIG. 5, there is shown a stabilizing hinge block 52 in greater detail. Hinge block 52 is, for example, formed of rubber, such as natural rubber or vulcanized rubber, or plastic and provides for additional flexibility such that upon impact, leg 16, for example, folds in. According to the present invention, at impact, the lower fender leg(s) 16 and lower coupler attachment 34 are weaker than upper panel 12 and upper coupler attachment 30, allowing lower leg(s) to fold in or breakaway without transferring any damage to the upper panel 12 of the wheel opening fender panel assembly. Upon minor impact, lower fender leg(s) 16 fold in and shear attachment members 28, for example plastic mounting bolts and plastic alignment guide pins, simultaneously compressing compression spring mounting bolt 28A to allow lower fender leg(s) 16 to momentarily separate from upper panel 12. The moment after impact, the compression spring mounting bolt 28A of coupler 18 decompresses and pulls the damaged lower fender leg 16 back into position. It is also feasible to utilize a bungee, or a plurality of bungees, to hold lower leg 16 to upper panel 12 if impact breaks attachment members 28.

Accordingly, when minor impact damage occurs, lower fender leg(s) 16 can be disposed of or repaired. Upon major impact to the lower fender leg(s) 16, the lower fender leg(s) 16 can easily be detached from the coupler without transferring damage to upper panel 12. The replacement leg(s) 16 are produced to tolerance specifications or standards which allow for easy removal of the damaged portion and reattachment with replacement attachment members 28.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A wheel opening fender panel assembly for a vehicle, comprising:
an upper panel;
a lower portion defining at least one leg; and
at least one coupler for removably coupling said upper panel and said lower portion, each said coupler being one of a folding coupler and a break-a-way coupler.

2. The wheel opening fender panel assembly according to claim 1, said upper panel and said lower portion each defining a flange configured for attachment together using a corresponding said coupler.

3. The wheel opening fender panel assembly according to claim 2, said coupler including at least one attachment member.

4. The wheel opening fender assembly according to claim 3, said at least one attachment member being at least one of a rigid metal bolt, a bendable metal bolt, a bendable composite bolt, a breakable composite bolt, a composite breakable guide pin, a metal guide pin, a compression spring, a spacer, a flexible hinge, a composite bungee and a lanyard.

5. The wheel opening fender panel assembly according to claim 3, said at least one attachment member being a plurality of attachment members.

6. The wheel opening fender panel assembly according to claim 5, said plurality of attachment members including at least one mounting bolt and at least one alignment guide pin.

7. The wheel opening fender assembly according to claim 6, said at least one mounting bolt being at least one spring bolt.

8. The wheel opening fender assembly according to claim 7, said coupler being formed from at least one of a metal, a composite material, a plastic and a rubber.

9. The wheel opening fender assembly according to claim 2, further comprising a stabilizing hinge block positioned at least one of between and around said flanges of each of said upper panel and said lower portion in a compression fit with said coupler.

10. The wheel opening fender assembly according to claim 9, said stabilizing hinge block formed of one of synthetic rubber, vulcanized rubber, natural rubber, polymeric material, and plastic.

11. The wheel opening fender assembly according to claim 2, said at least one leg being a plurality of legs.

12. The wheel opening fender assembly according to claim 11, said plurality of legs including a forward fender leg and an aft fender leg.

13. The wheel opening fender assembly according to claim 1, said upper panel having a greater rigidity than said lower portion.

14. The wheel opening fender assembly according to claim 1, wherein said coupler is configured to one of fold in and break-away upon impact at said lower portion.

15. A wheel opening fender assembly, comprising:
an upper panel including a flange;
a lower portion defining at least one lower leg and a flange; and
a coupler for removably coupling said flange of said upper panel and said flange of said lower portion, said coupler being one of a folding coupler and a break-a-way coupler.

16. The wheel opening fender assembly according to claim 15, said coupler including at least one attachment member.

17. The wheel opening fender assembly according to claim 16, said at least one attachment member being at least one of a rigid metal bolt, a bendable metal bolt, a bendable composite bolt, a breakable composite bolt, a composite breakable guide pin, a metal guide pin, a compression spring, a spacer, a flexible hinge, a composite bungee and a lanyard.

18. The wheel opening fender assembly according to claim 16, said at least one attachment member being a plurality of attachment members.

19. The wheel opening fender assembly according to claim 18, said plurality of attachment members including at least one spring bolt and at least one alignment guide pin.

20. The wheel opening fender assembly according to claim 15, further comprising a stabilizing hinge block positioned at least one of between and around said flanges of each of said upper panel and said lower portion in a compression fit with said coupler.
